(19) United States
(12) Patent Application Publication
(10) Pub. No.: US 2003/0233999 A1
(43) Pub. Date: Dec. 25, 2003

(54) Regenerative internal combustion engine

(76) Inventor: Thomas W. Anderson, Apex, NC (US)

Correspondence Address: Thomas W. Anderson, 1209 Boxwood Lane, Apex, NC, 27502, US

(21) Appl. No.: 10/177,372

(22) Filed: Jun. 24, 2002

(51) Int. Cl. F02B 75/02

(52) U.S. Cl. 123/316; 123/321

(57) ABSTRACT

A four-stroke cycle I C E with a special cylinder head containing three valves per cylinder, an air accumulator, carburetor, and special air inlet valve for use during coasting. Valves and fuel injection being computer controled such that the two exit valves are opened or closed at such times that either the products of combustion are after power strokes and the alternate exhaust valve opens when the vehicle is coasting alowing compressed air to go to the accumulator. Two air inlets are provided for the two ocassions. Necessary computer controls included.

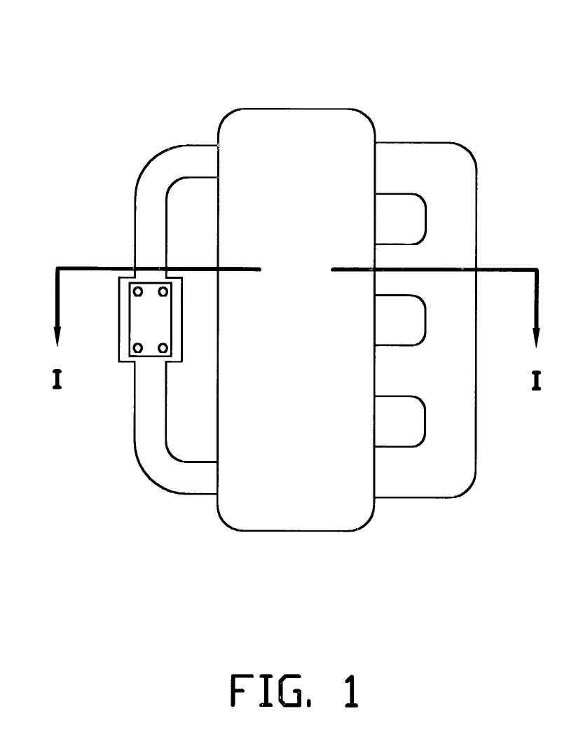

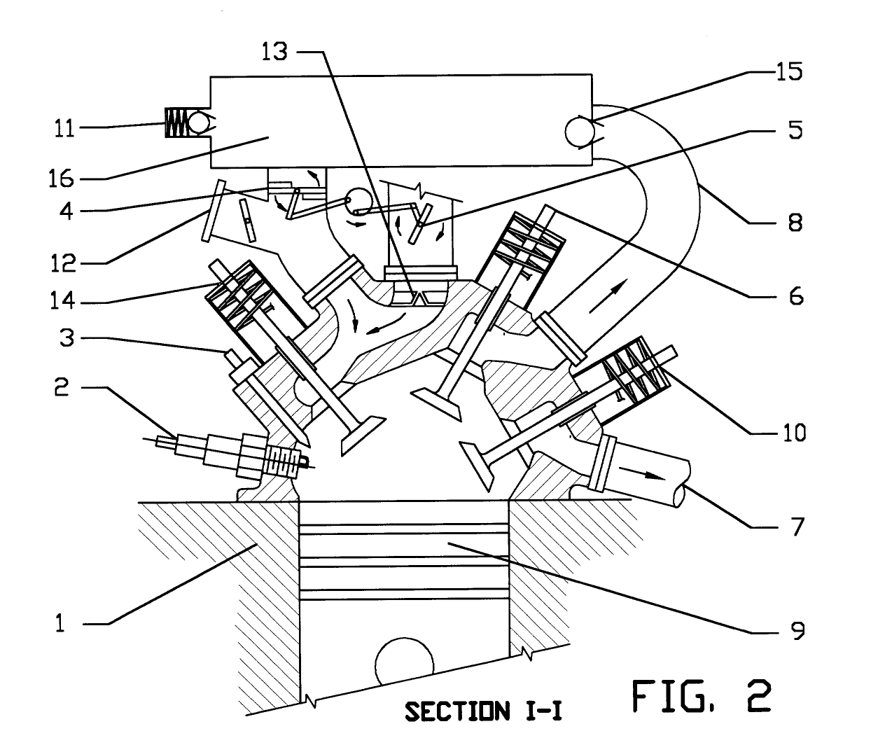

### FIELD OF THE INVENTION

Internal Combustion Engines

History:

The internal combustion engine is an outgrowth of the steam engine, since they both are basically a cylinder with a piston reciprocating in said cylinder controlled by a crankshaft. The steam engine has external combustion, the internal combustion engine is just that.

The I.C.E. of today is the four stroke cycle that Otto of Germany invented, and basically has not been improved since.

This document depicts a completely redesigned cylinder head which can control the strokes so as to have fuel dispensed only when power is called for and energy is saved and stored when the vehicle is coasting and power is not needed.

### DESCRIPTION

The basic block, pistons and crankshaft would remain as the have been and would work in the conventional fashion, I.E. the four stroke Otto cycle.

The call outs in the drawing are 1, engine block, 2, spark plug, 3, fuel injector nozzle, 4, accumulator valve, 5, throttle body valve, 6, 10 and 14, computer controlled valves, 7, exhaust manifold, 8, outlet port/manifold for compressed air to accumulator, 9, piston, 11, excess pressure release valve, 12 coasting air inlet port, 13, one way check valve, 15, one way check valve. 16 is the accumulator.

When the engine is started and there is no pressure in the accumulator, No.5 valve would open according to the accelerator pedal setting, compression, fuel injection ignition, and exhaust would occur in the usual sequence.

When power is called for and there is pressure in the accumulator, the pressure sensor would switch control from valve 5 to 4. Four would open according to the setting of the accelerator pedal, a proportional amount of air would be admitted to the combustion chamber from the accumulator. Fuel injection and other strokes of the cycle would occurs including exhaust valve 10 opening.

When the call for power is diminished or entirely cut off, low pressure in the manifold would draw air thru spring loaded valve no. 12. No fuel would be injected at this juncture. Compression would occurs, valve no. 6 would open, check valve No. 15 would be forced open, admitting air to the accumulator 16. If this results in pressure above a predetermined limit, valve No. 11 would be forced open and excess would be admitted to the atmosphere.

No unburned or partially burned fuel would be admitted to the atmosphere when the vehicle is coasting because no fuel is being drawn when power is not called for.

When slowing the vehicle is desired the resistance caused by the compression strokes helps to slow the vehicle which saves on brake wear.

The momentum of the vehicle will regenerate energy in the form of stored air under pressure which would be utilized during the next demand for power.

### ADVANTAGES

Less pollution

Greater fuel economy

Less brake wear.

What is claimed is:

1. a four-stroke cycle internal combustion engine wherein the strokes are defined by a cylinder head(s) having three valves per cylinder: an intake, exhaust, compressed air outlet, a conventional carburetor, and an air inlet valve ror coasting.
